(19) United States
(12) Patent Application Publication
(10) Pub. No.: US 2005/0189825 A1
(43) Pub. Date: Sep. 1, 2005

(54) Bistable rotary solenoid

(76) Inventors: Philipp Brodt, Littleton, NH (US); Dhaval R. Desai, West Haven, CT (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 11/045,601

(22) Filed: Jan. 28, 2005

Related U.S. Application Data
(60) Provisional application No. 60/540,303, filed on Jan. 29, 2004.

(51) Int. Cl. H01F 7/08; H01F 7/18

(52) U.S. Cl. 310/32; 335/272; 335/228

(57) ABSTRACT

A rotary solenoid comprises: a ferromagnetic core having a rotatable shaft disposed through an axial aperture in the core; a permanently magnetized armature fixedly mounted relative to a first end of the shaft, the armature having a pair of pole portions of opposite magnetic polarity; a first stator pole coupled to the first end of the core and extending proximate the armature; a second stator pole coupled to the second end of the core and extending proximate the armature; and a winding disposed around the core, wherein the rotor rotates from a first position to a second position in response to a direct electrical current in a first direction through the winding, and the rotor rotates from the second position to the first position in response to a direct current in a second direction through the winding. The first and second stator poles may be curved around the outer circumference of armature and spaced apart therefrom. A plate may be fixed relative to one of the rotor and the core and a protrusion fixed relative to the other of the rotor and the core, wherein the protrusion is received within a slot disposed in the plate for defining the angle of rotation between the first and second positions. The rotary solenoid may be used in an image enhancement device such as a night and low-light vision device or a thermal imaging device for driving a shutter between open and closed positions.

### CROSS-REFERENCE TO RELATED APPLICATIONS

This application claims the benefit of U.S. Provisional Patent Application No. 60/540,303 filed Jan. 29, 2004 and entitled “Bistable Rotary Solenoid”, which is incorporated by reference herein in its entirety.

### BACKGROUND OF THE INVENTION

1. Field of the Invention

This invention relates to rotary solenoids. More specifically, this invention relates to bistable rotary solenoids.

2. Description of the Related Art

In rotary solenoids, electrically energizing a winding produces movement of a shaft. In certain prior art rotary solenoids magnetic attraction generated by energizing the winding attracts an armature to move the shaft in one direction and tensions a coil spring which moves the shaft in the other direction when the winding is deenergized. In this type of prior art rotary solenoid it is difficult to provide equal torque in both directions since electromagnetism is the motive power in one direction and resilient energy is the motive power in the other direction. In addition, this type of rotary solenoid is stable in only one position. That is, as soon as electrical power is removed, the shaft moves in the direction of the spring bias. While such operation is advantageous for some applications, in applications where the shaft must be positioned against the spring bias for long periods of time, the constant electrical energy required to keep the shaft in this position can drain electrical power.

These problems may be avoided by the addition of a mechanical detent to hold the shaft in position against the spring bias. These problems may also be avoided by another type of prior art rotary solenoid that uses a separate winding for each direction of movement, thus eliminating the need for a return spring. However, the use of mechanical detents or two windings results in a structure that is relatively heavy, bulky, and expensive in relation to the single winding, spring returned type.

U.S. Pat. No. 4,736,175, which is incorporated by reference herein in its entirety, describes a rotary solenoid providing opposite direction pivotal movement on opposite polarity direct current (DC) energizing of a winding. The solenoid has a pivoting shaft from which a permanent magnet armature having ends of opposite magnetic polarity extends transversely and oppositely. The armature is disposed between a pair of pole pieces, each of which extends along the armature between its ends. The pole pieces are oppositely electromagnetically magnetized by a DC winding so that reversing the DC polarity at terminals of the winding reverses the direction of pivotal movement of the shaft without using a spring. The solenoid described therein is bistable. That is, permanent magnetic attraction between the armature and the pole pieces causes the armature to be retained in either of its end positions after the winding is deenergized. However, while the solenoid described in the '175 application is bistable, it is not sufficiently compact for applications where the solenoid must be included in small, portable devices. Thus, there is a need for a compact, bistable rotary actuator.

### BRIEF SUMMARY OF THE INVENTION

The above-described and other needs are met by a rotary solenoid comprising: a ferromagnetic core having an aperture disposed through its longitudinal axis, the core having a first end and an opposing second end; a rotatable shaft disposed through the aperture and coaxially aligned with the ferromagnetic core, the rotatable shaft having a first end extending outward from the first end of the ferromagnetic core and a second end extending outward from the second end of the ferromagnetic core; a permanently magnetized armature fixedly mounted relative to the first end of the shaft, the armature having a pair of pole portions of opposite magnetic polarity; a first stator pole coupled to the first end of the core and extending proximate the armature; a second stator pole coupled to the second end of the core and extending proximate the armature, the first and second stator poles being diametrically opposed relative to the armature; and a winding disposed around the core, wherein the rotor rotates from a first position to a second position in response to a direct electrical current in a first direction through the winding, and the rotor rotates from the second position to the first position in response to a direct current in a second direction through the winding. In a preferred embodiment, the armature is a disc having its center fixedly mounted centrally on the first end of the shaft, and the first and second stator poles are curved around the outer circumference of the disc and spaced apart therefrom. The rotary solenoid may further include a plate fixed relative to one of the rotor and the core, and a protrusion fixed relative to the other of the rotor and the core. The protrusion is received within a slot disposed in the plate for defining the angle of rotation between the first and second positions.

In one aspect, the rotary solenoid includes a housing containing the core, the shaft, the armature, the first and second stator poles, the winding, and a portion of the shaft, wherein the second end of the shaft extends from the housing. The rotary solenoid may also include a flag fixedly attached to the second end of the shaft, the shaft rotating the flag between the first position and the second position. The flag may be, for example, a shutter for allowing the passage of light in the first position and interfering with the passage of light in the second position. In another example, the shutter may be a flag used as an indicator.

In one embodiment, the rotary solenoid is used in an image enhancement device comprising: a sensor responsive to thermal energy; a shutter movable between a first position and a second position, the shutter allowing the passage of the thermal energy to the sensor in the second position and blocking the passage of thermal energy to the sensor in the first position; with the rotary solenoid coupled to the shutter for driving the shutter between the first and second positions. The radiant energy may include one or more of: light beams, infrared beams, and laser beams, and the sensor may include one or more of: a charge coupled device, a photo detecting element, an infrared detector element, and an image intensifier tube. The image enhancement device may include, for example, at least one of a night and low-light vision device and a thermal imaging device.

The details of one or more embodiments of the invention are set forth in the accompanying drawings and the description below. Other features, objects and advantages of the invention will be apparent from the description and drawings, and from the claims.

### BRIEF DESCRIPTION OF THE DRAWINGS

The invention will be more fully understood from the following detailed description taken in conjunction with the accompanying drawings wherein like elements are numbered alike, and in which:

FIG. 1 is a cross-sectional side view of a bistable rotary actuator of the present invention;

FIG. 2 is a cross-sectional end view of the bistable rotary actuator of FIG. 1;

FIG. 3 is a side view of the bistable rotary actuator of FIG. 1 having a flag attached thereto; and

FIG. 4 is an end view of the bistable rotary actuator of FIG. 3.

### DETAILED DESCRIPTION

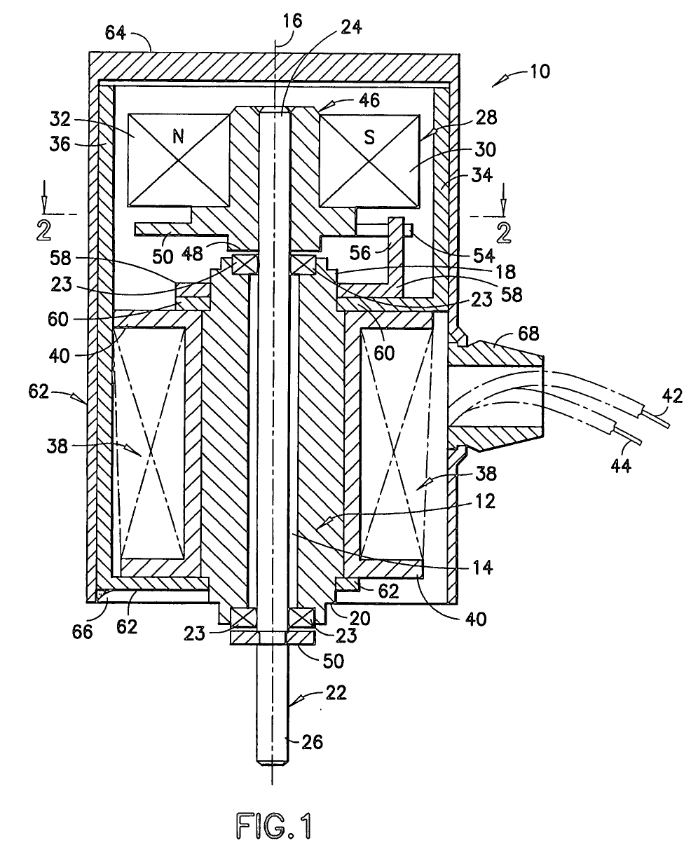

Referring to FIG. 1, a bistable rotary solenoid is shown generally at 10. The solenoid 10 includes a ferromagnetic core 12 having an aperture 14 disposed along its longitudinal axis 16. The core 12 has a first end 18 and an opposing second end 20. A shaft 22 extends through the aperture 14 and coaxially aligned with the ferromagnetic core 12. The shaft 22 may be supported within the aperture 14 by bearings 23, which allow the shaft 22 to rotate about the longitudinal axis 16 relative to the core 12 while maintaining coaxial alignment between the core 12 and shaft 22. The rotatable shaft 22 has a first end 24 extending outward from the first end 18 of the ferromagnetic core 12 and a second end 26 extending outward from the second end 20 of the ferromagnetic core 12. A permanently magnetized armature 28 is fixedly mounted relative to the first end 24 of the shaft 22 such that the armature 28 and shaft 22 rotate as one. The armature 28 includes a pair of pole portions 30, 32 of opposite magnetic polarity. A first stator pole 34 is coupled to the first end 18 of the core 12 and extends proximate the armature 28. A second stator pole 36 is coupled to the second end 20 of the core 12 and extends proximate the armature 28. The first and second stator poles 34, 36 are diametrically opposed relative to the armature 28. A winding 38, which may be formed from conductive wire (e.g., copper wire), is wrapped around a dielectric bobbin 40, which is disposed around the core 12. The winding 38 has two leads 42 and 44, which are configured for connection to an external direct current (DC) electrical power supply and control system.

In the embodiment shown, the armature 28 is fixedly attached to a hub 46, which in turn is fixedly attached to the shaft 22. One face of the hub 46 forms a shoulder 48, which acts against the bearing 23 at the first end 18 of the core 12 to support the shaft 22 in an axial direction. Similarly, a circular plate 50 is attached to the shaft 22 proximate the second end 20 of the core 12. The plate 50 acts against the bearing 23 at the second end 20 of the core 12 to support the shaft 22 in an axial direction. The hub 46 also forms a circular plate 52, which is disposed between the armature 28 and the core 12. The circular plate 52 has a slot 54 disposed therein for receiving a protrusion 56 fixed relative to the core 12. In the embodiment shown, the protrusion 56 is formed on a plate 58, which has an aperture for receiving the first end 18 of the core 12. Similarly, the first stator pole 34 is formed on a plate 60 that has an aperture for receiving the first end 18 of the core 12, and the second stator pole 36 is formed on a plate 62 that has an aperture for receiving the second end 20 of the core 12. The protrusion 56, first stator pole 34, second stator pole 36, and winding 38 are all fixed relative to the core 12.

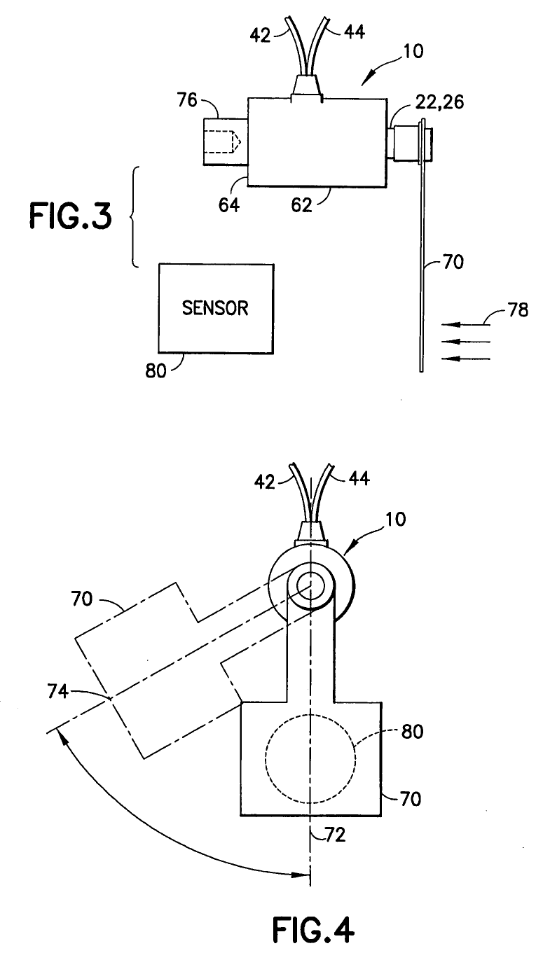

The armature 28 may be a disc having its center fixedly mounted centrally relative to the first end of the shaft 22, with the first and second stator poles 34, 36 being curved around the outer circumference of the disc, as shown in FIG. 3, and spaced apart therefrom. In the embodiment shown, for example, the first and second stator poles 34, 36 are each curved to form a 90° arc relative to the longitudinal axis 16. As also shown in FIG. 3, the slot 54 formed in plate 50 is arcuate and is defined by end faces 60 and 61, which act against the protrusion 56 to define the maximum angle of rotation of the rotor 28 and shaft 22 about the longitudinal axis 16. In the embodiment shown, this angle of rotation is about 65°. It will be appreciated, however, that the angle defined by the end faces 60 and 61 may be increased or decreased as necessary up to about 90 degrees to set the angle of rotor 28 and shaft 22 rotation for a particular application.

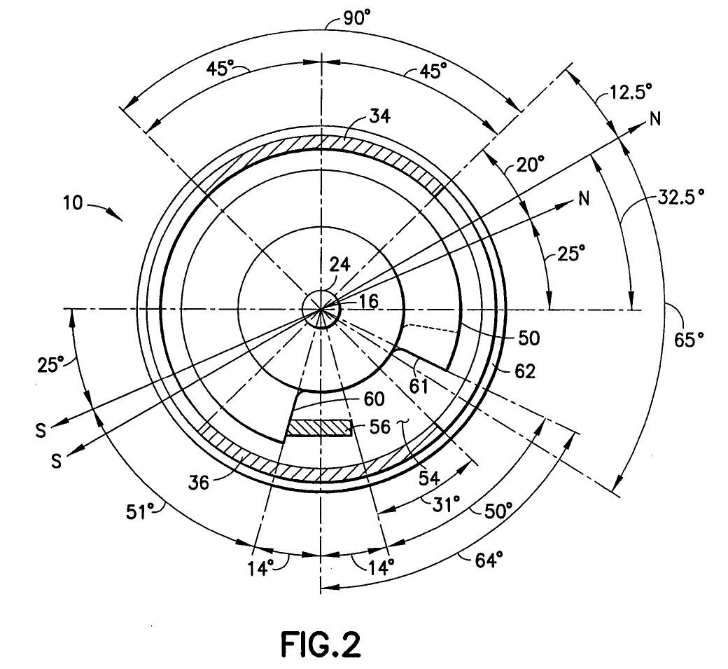

Referring to FIGS. 1 and 2, the rotary solenoid 10 preferably includes a cylindrical housing 62 having a closed end 64 and an open end 66. The cylindrical housing 62 contains the core 12, the armature 28, the first and second stator poles 24, 26, the winding 38, and a portion of the shaft 22. The second end 26 of the shaft 22 extends from the open end 66 of the housing 62 for attachment to any mechanical device that the rotary solenoid 10 is to drive. The open end 66 of the housing 62 may be sealed to prevent the ingress of contaminants such as water, dust, and the like. A resilient grommet 68 may be disposed around the leads 42, 44 and secured to the housing 62 to prevent the ingress of such contaminants.

As can be seen in FIGS. 1 and 2, the inside diameter of the housing 62 conforms to the curvature of the first and second stator poles 24, 26 and generally conforms to the outside diameter of the bobbin 40, thus allowing the rotary solenoid 10 to be both durable and compact in size. For example, the rotary solenoid 10 may have an outside diameter (i.e., the outside diameter of the housing 62) of about ⅜ inches, and a length of about 9/16 inches.

In operation, the rotor 28 rotates in a first direction from a first position to a second position in response to a direct electrical current in a first direction through the winding 38, and the rotor rotates in a second, opposite direction from the second position to the first position in response to a direct current in a second direction through the winding 38. The change in direction of direct current through the winding may be accomplished by switching the polarity of the electrical current (±) applied to the leads 42 and 44. The rotation angle between the first and second positions is defined by the slot 54 in the plate 50, as shown in FIG. 2. The rotary solenoid 10 is bistable, with permanent magnetic attraction between the armature 28 and the stator poles 34, 36 causing the armature 28 to be retained in either of the first or second positions after the winding 38 is deenergized.

Referring to FIGS. 3 and 4, the rotary solenoid 10 may also include a flag 70 fixedly attached to the second end 26 of the shaft 22. As shown in FIG. 3, the shaft 22 rotates the flag 70 between the first position 72 and the second position 74. The rotary solenoid 10 may further include a threaded nut 76 attached to the closed end 64 of the housing 62 for securing the rotary solenoid 10 to a solid platform.

In one embodiment, the flag 70 is a shutter for controlling the passage of radiant energy, generally indicated at 78, to a sensor 80. Radiant energy 78 may include light beams, infrared beams, laser beams and the like. Sensor 80 may be any sensor that provides an output indicative of one or more properties of the radiant energy 78. For example, sensor 80 may include one or more of a charge coupled device, photo detecting elements, infrared detector elements, an image intensifier tube, or the like, as found in image enhancement devices such as night and low-light vision devices and thermal imaging devices. It will be appreciated that one or more optical enhancing elements, such as lenses, mirrors, and the like, may be disposed between the shutter 70 and the sensor 80.

In operation, the flag 70 is moved to the second position 74 to allow the passage of thermal energy 78 to the sensor 80, and is moved to the first position 72 to block the thermal energy 78 from the sensor 80. Because the rotary solenoid 10 is bistable, the flag 70 is maintained in either the first or second positions 72, 74 even when electrical current is removed from the leads 42, 44. The flag 70 may also be moved quickly from the second position 74 to the first position 72 and back to the second position 74 to temporarily block the thermal energy 78 from the sensor 80. This quick opening and closing of the shutter (flag 70) may be effective to clear or prevent a condition of sensor 80 overload resulting from an increase in intensity of the thermal energy 78 and, as a result, clear any image blurring or ghosting associated with the overload of sensor 80.

The rotary solenoid 10 is particularly suited for use in portable image enhancement devices such as night and low-light vision devices and thermal imaging devices. Because the rotary solenoid 10 is bistable, the rotary solenoid 10 of the present invention allows the flag 70 to be positioned in either position 72 or 74 for extended periods of time without draining in electrical power, which is typically provided by batteries in portable image enhancement devices. In addition, the rotary solenoid 10 is compact in size, allowing it to be implemented in small and lightweight image enhancement devices.

While the embodiment of FIGS. 3 and 4 are particularly drawn to the use of the rotary solenoid 10 as a shutter apparatus, the rotary solenoid 10 may be used in other applications as well. For example, the rotary solenoid 10 may be used to drive an indicator flag, such as those found on control panels. It will be appreciated that the energy conservation features and compact size provided by the rotary solenoid 10 would be advantageous in most any application.

A number of embodiments of the present invention have been described. Nevertheless, it will be understood that various modifications may be made without departing from the spirit and scope of the invention. Accordingly, other embodiments are within the scope of the following claims.

1. A rotary solenoid comprising:
a ferromagnetic core having an aperture disposed along its longitudinal axis, the core having a first end and an opposing second end;
a rotatable shaft extending through the aperture and coaxially aligned with the ferromagnetic core, the rotatable shaft having a first end extending outward from the first end of the ferromagnetic core and a second end extending outward from the second end of the ferromagnetic core;
a permanently magnetized armature fixedly mounted relative to the first end of the shaft, the armature having a pair of pole portions of opposite magnetic polarity;
a first stator pole coupled to the first end of the core and extending proximate the armature;
a second stator pole coupled to the second end of the core and extending proximate the armature, the first and second stator poles being diametrically opposed relative to the armature; and
a winding disposed around the core, wherein the rotor rotates from a first position to a second position in response to a direct electrical current in a first direction through the winding, and the rotor rotates from the second position to the first position in response to a direct current in a second direction through the winding.

2. The rotary solenoid of claim 1, further comprising:
a housing containing the core, the shaft, the armature, the first and second stator poles, the winding, and a portion of the shaft, wherein the second end of the shaft extends from the housing.

3. The rotary solenoid of claim 2, further comprising:
a flag fixedly attached to the second end of the shaft, the shaft rotating the flag between the first position and the second position.

4. The rotary solenoid of claim 3, wherein the flag is a shutter for controlling the passage of radiant energy.

5. The rotary solenoid of claim 4, wherein the shutter controls the passage of radiant energy to a sensor in an image enhancement device.

6. The rotary solenoid of claim 3, wherein the flag is an indicator.

7. The rotary solenoid of claim 2, wherein the armature is a disc having its center fixedly mounted centrally on the first end of the shaft, and the first and second stator poles are curved around the outer circumference of the disc and spaced apart therefrom.

8. The rotary solenoid of claim 7, further comprising:
a plate fixed relative to one of the rotor and the core; and
a protrusion fixed relative to the other of the rotor and the core, the protrusion being received within a slot disposed in the plate for defining the angle of rotation between the first and second positions.

9. A rotary solenoid comprising:
a cylindrical housing;
a ferromagnetic core contained in the housing and coaxially aligned therewith, the core having a first end and an opposing second end;
a rotatable shaft extending through core and coaxially aligned therewith, the shaft having a first end extending outward from the first end of the ferromagnetic core and a second end extending outward from the second end of the ferromagnetic and outward from the housing;
a permanently magnetized armature contained in the housing and fixedly mounted relative to the first end of the shaft, the armature having a pair of pole portions of opposite magnetic polarity;
a first stator pole contained in the housing, the first stator pole being coupled to the first end of the core and extending proximate the armature;
a second stator pole contained in the housing, the second stator pole being coupled to the second end of the core and extending proximate the armature, the first and second stator poles being diametrically opposed relative to the armature and curved to conform with an inside diameter of the housing and an outside diameter of the armature; and
a winding disposed around the core, wherein the rotor rotates from a first position to a second position in response to a direct electrical current in a first direction through the winding, and the rotor rotates from the second position to the first position in response to a direct current in a second direction through the winding.

10. The rotary solenoid of claim 9, further comprising:
a flag fixedly attached to the second end of the shaft, the shaft rotating the flag between the first position and the second position.

11. The rotary solenoid of claim 10, wherein the flag is a for controlling the passage of radiant energy.

12. The rotary solenoid of claim 11, wherein the shutter controls the passage of radiant energy to a sensor in an image enhancement device.

13. The rotary solenoid of claim 10, wherein the flag is an indicator.

14. The rotary solenoid of claim 9, further comprising:
a plate fixed relative to one of the rotor and the core; and
a protrusion fixed relative to the other of the rotor and the core, the protrusion being received within a slot disposed in the plate for defining the angle of rotation between the first and second positions.

15. An image enhancement device comprising:
a sensor responsive to thermal energy;
a shutter movable between a first position and a second position, the shutter allowing the passage of the thermal energy to the sensor in the second position and blocking the passage of thermal energy to the sensor in the first position; and
a rotary solenoid coupled to the shutter for driving the shutter between the first and second positions, the rotary solenoid including:
a ferromagnetic core having an aperture disposed along its longitudinal axis, the core having a first end and an opposing second end,
a rotatable shaft extending through the aperture and coaxially aligned with the ferromagnetic core, the rotatable shaft having a first end extending outward from the first end of the ferromagnetic core and a second end extending outward from the second end of the ferromagnetic core, the shutter being mounted to the second end of the shaft,
a permanently magnetized armature fixedly mounted relative to the first end of the shaft, the armature having a pair of pole portions of opposite magnetic polarity,
a first stator pole coupled to the first end of the core and extending proximate the armature,
a second stator pole coupled to the second end of the core and extending proximate the armature, the first and second stator poles being diametrically opposed relative to the armature, and
a winding disposed around the core, wherein the rotor rotates from a first position to a second position in response to a direct electrical current in a first direction through the winding, and the rotor rotates from the second position to the first position in response to a direct current in a second direction through the winding.

16. The image enhancement device of claim 15, further including:
a housing containing the core, the shaft, the armature, the first and second stator poles, the winding, and a portion of the shaft, wherein the second end of the shaft extends from the housing.

17. The image enhancement device of claim 15, wherein the armature is a disc having its center fixedly mounted centrally on the first end of the shaft, and the first and second stator poles are curved around the outer circumference of the disc and spaced apart therefrom.

18. The image enhancement device of claim 17, further comprising:
a plate fixed relative to one of the rotor and the core; and
a protrusion fixed relative to the other of the rotor and the core, the protrusion being received within a slot disposed in the plate for defining the angle of rotation between the first and second positions.

19. The image enhancement device of claim 15, wherein the radiant energy includes one or more of: light beams, infrared beams, and laser beams, and wherein the sensor includes one or more of: a charge coupled device, a photo detecting element, an infrared detector element, and an image intensifier tube.
